(19) United States
(12) Patent Application Publication
(10) Pub. No.: US 2008/0195630 A1
(43) Pub. Date: Aug. 14, 2008

(54) Web service interrogation method and apparatus

(75) Inventors: Raphael Exartier, Grasse (FR); Remi Guelton, Rebreuve-Ranchicourt (FR)

Correspondence Address: Gregory J. Lavorgna;DRINKER BIDDLE & REATH LLP, One Logan Square, 18th and Cherry Streets, Philadelphia, PA, 19103-6996, US

(73) Assignee: Amadeus S.A.S.

(21) Appl. No.: 11/705,647

(22) Filed: Feb. 13, 2007

(51) Int. Cl. G06F 17/30

(52) U.S. Cl. 707/10

(57) ABSTRACT

A web service interrogation method comprises receiving natural language request data at a processor. The processor parses the request data. A data structure comprising a directory of web service resources is interrogated based upon the parsed input data. Fields within a web service identified from said data structure are matched to the parsed input data. Service data records corresponding to at least some of said webs service resources that fulfill a matching criteria to the request data are aggregated. The service data is output to a user. A web service interrogation apparatus is also disclosed.

### FIELD OF THE INVENTION

The present invention relates to a web service interrogation method and apparatus.

### BACKGROUND TO THE INVENTION

Typically, the interrogation of web based services by a user involves the user completing web based forms in order to interrogate the underlying database. For example to determine the availability of flights on a particular route it is often necessary to complete three or four web forms for any given carrier. Where the user wishes to compare the results from a number of web services the same information will often have to be entered repetitively. This is time consuming and exasperating for the user. Furthermore, the requirement to enter information into web forms repeatedly increases the likelihood of the information being entered onto one or more of the forms incorrectly. Typically, this requires the whole data entry process to be commenced again, with an attendant increase in time wastage and user exasperation.

An attempt to solve this problem has been made by the use of a web engine that searches the Internet, or a companies intranet, for a web service that has a Universal Description, Discovery, and Integration (UDDI) identifier that most closely matches that of a user entered request.

However, this method merely returns a suggested starting point for the user to access in order to fulfill their query. Furthermore, this method has no way of querying the web service intelligently on the user's behalf.

### SUMMARY OF THE INVENTION

According to a first aspect of the present invention there is provided a web service interrogation method comprising the steps of:

(i) receiving natural language request data at a processor;

(ii) parsing said request data at the processor;

(iii) interrogating a data structure comprising a directory of web service resources based upon the parsed input data;

(iv) matching fields within a web service identified from said data structure to the parsed input data; characterised by

(v) aggregating service data records corresponding to at least some of said webs service resources that fulfill a matching criteria to said request data; and

(vi) outputting said service data to a user.

Such a method allows a user to input a natural language request to a system and to interrogate a large number of web services without the need to fill in multiple forms. Furthermore, such a method allows a user to have a large number of results returned in response to a single natural language request. This results in an increase of ease of use of the method of interrogating web services.

The method may comprise receiving said natural language request data from a speech recognition apparatus.

The method may comprise identifying a domain within the data structure to interrogate from the parsed input data.

The data structure may comprise a large number of domains, for example travel and insurance. Identifying the domain to interrogate reduces the likelihood of spurious service data being returned. This reduces the amount of data transferred across the network.

The data structure may comprise interrogating said data structure using UDDI.

The method may comprise matching said fields with the parsed data within said data structure by the use of a descriptor schema. The method may comprise matching said fields using WSDL.

Such a descriptor schema is a hierarchical structure that defines a platform independent registry for businesses with standard descriptors of fields.

The method may comprise outputting query data to the user should the number of service data records aggregated exceed a pre-determined threshold.

This reduces the volume of data transferred across the network. The aggregation of data records increases the relevance of the result returned to the user compared to the prior art methods.

The method may comprise outputting query data to the user should the number of service data records aggregated lie below a pre-determined threshold. The method may comprise outputting query data to the user should the parsed data be insufficient to match to all fields within the data structure in order to aggregate service data records. The method may comprise parsing further natural language input data, input in response to said query data. The method may comprise repeating stages (iv) to (vi) in response to the further parsed input data.

According to a second aspect of the present there is provided a web service interrogation apparatus comprising:

a processor;

a natural language data input device;

a display device;

the data input device being arranged to receive a natural language request data and to pass said request data to the processor;

the processor being arranged to parse said request data;

the processor being arranged to interrogate a data structure comprising a directory of web service resources based upon the parsed input data and being further arranged to match fields within a web service identified from said data structure to the parsed input data; characterised by

the processor being arranged to aggregate service data records corresponding to at least some of said webs service resources that fulfill a matching criteria to said request data; and

the processor being arranged to output said service data for display at the display device.

The data structure may be hosted upon a data storage device remote from the processor. The processor may be arranged to access the data structure via a network, typically the Internet.

The data structure may comprise data entries relating a number of domains. The processor may be arranged to identify which domain to interrogate from the parsed input data.

The processor may be arranged to match said mandatory field with the parsed input data within said data structure by the use of a descriptor schema. The descriptor schema may comprise Universal Description Discovery and Integration (UDDI). The fields may be described using Web Services Description Language (WSDL).

The processor may be arranged to output query data to via the display device should the number of service data records aggregated exceed a pre-determined threshold.

The processor may be arranged to output query data via the display device should the number of service data records aggregated lie below a pre-determined threshold. The processor may be arranged to output query data to the user should the parsed data be insufficient to match to all fields within the data structure required in order to aggregate service data records. The processor may be arranged to parse a further natural language input data, input in response to said query data. The processor may be arranged the processor being arranged to interrogate a data structure comprising a directory of web service resources based upon the further parsed input data and being further arranged to match fields within said data structure to the further parsed input data and wherein the processor being arranged to aggregate service data records corresponding to at least some of said webs service resources that fulfill a matching criteria to said request data, and the processor being arranged to output said service data for display at the display device.

The natural language input device may comprise any one, or combination, of the following: a keyboard, a voice recognition device, a mouse-display combination.

According to a third aspect of the present invention there is provided a processor arranged to operate as the processor of the second aspect of the present invention.

According to a fourth aspect of the present invention there is provided software which when executed upon a processor causes the processor to: receive natural language request data at a processor;

parse said request data at the processor;

interrogate a data structure comprising a directory of web service resources based upon the parsed input data;

match fields within an entry within said data structure to the parsed input data; characterised by

aggregate service data records corresponding to at least some of said webs service resources that fulfill a matching criteria to said request data; and

output said service data to a display device.

The software may cause the processor to access the data structure via a network. The software may cause the processor to interrogate the data structure using UDDI protocols.

The software may cause the processor to identify a domain to interrogate from the parsed input data.

The software may cause the processor to match said field with the parsed input data within said data structure by the use of a descriptor schema, for example Web services Description Language.

The software may cause the processor to output query data to via the display device should the number of service data records aggregated exceed a pre-determined threshold.

The software may cause the processor to output query data via the display device should the number of service data records aggregated lie below a pre-determined threshold. The software may cause the processor to output query data to the user should the parsed data be insufficient to match to all fields within the data structure required in order to aggregate service data records. The software may cause the processor to parse a further natural language input data, input in response to said query data. The software may cause the processor to interrogate a data structure comprising a directory of web service resources based upon the further parsed input data and may cause the processor to match fields within said data structure to the further parsed input data, the software may cause the processor to aggregate service data records corresponding to at least some of said webs service resources that fulfill a matching criteria to said request data, and the software may cause the processor to output said service data for display at the display device.

### BRIEF DESCRIPTION OF THE DRAWINGS

Embodiments of the present invention will now be described, by way of example only, with reference to the accompanying drawings, in which:

FIG. 1 is a schematic diagram of an embodiment of a web service interrogation apparatus in accordance with an aspect of the present invention; and

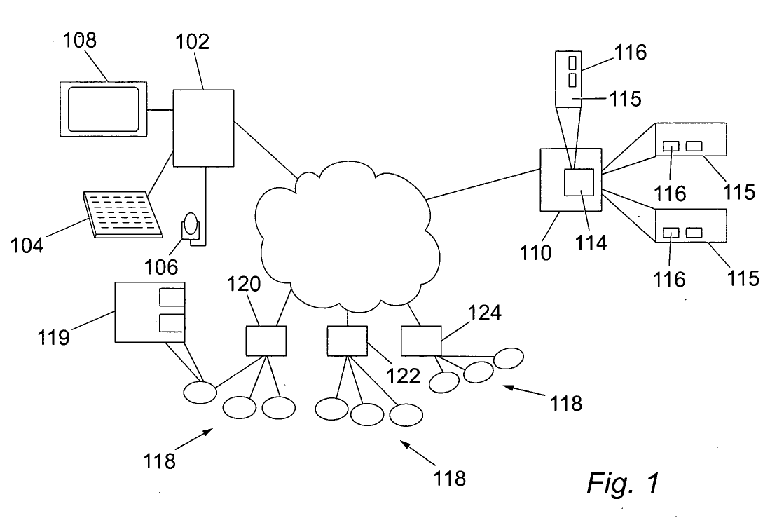

FIG. 2 is a flow chart detailing a method of web service interrogation according to another aspect of the present invention.

### DETAILED DESCRIPTION OF EMBODIMENTS

A web service interrogation apparatus 100 comprises a processor 102, a keyboard 104, a microphone 106 and a screen 108. The processor 102 connects to a remote server 110 via a network 112, typically the Internet.

The server 110 holds a descriptor schema data structure 114, typically Universal Description Discovery and Integration (UDDI). The schema 114 holds descriptions of many classes of service available via web service, for example flight details, insurance, restaurants, hotels and car hire. Each class of web service is termed a domain 115.

A user inputs a natural language request via either the keyboard 104, or the microphone 106 if voice recognition is in use. Data corresponding to natural language request data passes to the processor 102. For example a request may comprise “I wish to travel from Dublin to Nice on 17 November returning on the 18 November and stay on the Promenade Anglais with a table for dinner”.

The processor 102 parses and analyses the natural language request in a manner that will be known to those skilled in the art. This parsed data is compared to data entries 116 within the UDDI data structure 114 in order to determine the domains 115 that are to be interrogated further. In the previously cited example, the relevant domains 115 are “Flight”, “Hotel” and “Restaurant”.

The processor 102 then accesses web services 118 within the relevant domains 115 via the network 112. The web services 118 use descriptors of fields within web-forms. Typically, these descriptors are standardised abbreviations, for example Arr_Date for “Arrival Date” and Dep_Date for “Departure Date”. An exemplary type of web service field descriptor is WSDL.

The processor 102 matches descriptors to elements of the parsed input data within a web-form. The processor 102 then automatically fills in the required fields within the web-form on each web service 118 within the domain 115.

For example, Air Mur and Air Ama may provide flights between return Dublin and Nice on the dates requested. The processor 102 completes the web-form 119 for these requests at a server 120, which may be an airline server or may be an aggregated content server. The processor 102 then returns the results of the request to the user on the screen 104. Typically, for flight information the results of the request comprise time and date of flights, cost of flights and other schedule information.

Similarly, the “Hotel” domain 115 has sufficient information to interrogate a large number of databases. This may return one hundred and fifty results. The processor 102 determines that this is too many results for display to the user and issues a request to the user for further information via the screen 106. For example, the user may be asked “What class of hotel do you require 1 to 5 star?”.

The user inputs a natural language response via either the keyboard 104, or the microphone 106, for example “3 star or above”. The processor 102 parses this response and completes the web-form for these requests at a server 122 that hosts web services for booking hotels. It may be that the details of each hotel are not stored on an aggregated content server and processor 102 may have to interrogate a plurality of content servers in relation to different hotels. The processor returns the results of the request to the user on the screen 104, for example, room rate, availability etc.

Similarly, the “Restaurant” domain 115 does not sufficient information to interrogate databases on appropriate servers 124. The processor 102 determines that further information is require and issues a request to the user for further information via the screen 106. For example, the user may be asked “Where do you want to eat and any culinary preference?”.

The user inputs a natural language response via either the keyboard 104, or the microphone 106, for example “Seafront, French”. The processor 102 parses this response and completes the web-form for these requests at a server 124. Multiple servers may have to be accessed if an aggregated content server is not used. The processor and returns the results of the request to the user on the screen 104.

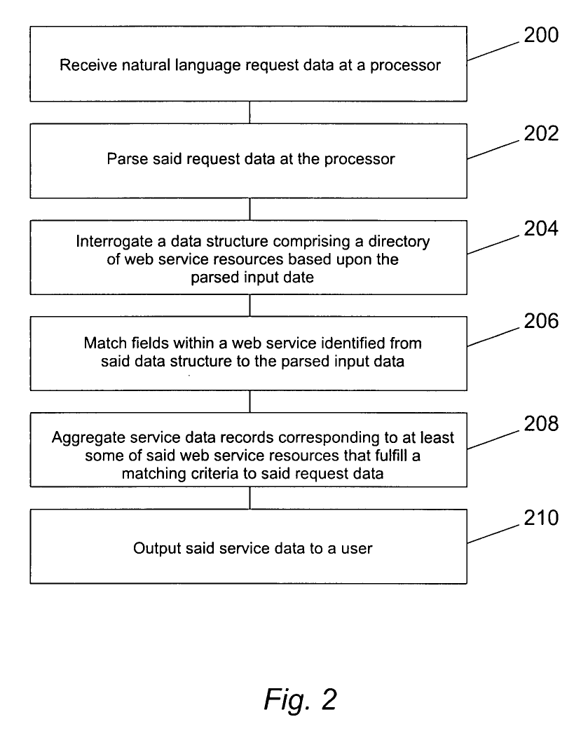

Referring now to FIG. 2, a web service interrogation method comprises receiving natural language request data at a processor (Step 200). The processor parses the request data (Step 202). A data structure comprising a directory of web service resources is interrogated based upon the parsed input data (Step 204). Fields within a web service identified from said data structure are matched to the parsed input data (Step 206). Service data records corresponding to at least some of said webs service resources that fulfill a matching criteria to the request data are aggregated (Step 208). The service data is output to a user (Step 210).

It will be appreciated that although described with reference to travel web services the present invention is equally applicable in any domain in which web-services searchable from a data structure and request data can be used to complete fields within web-forms.

While various embodiments of the invention have been described, it will be apparent to those skilled in the art once given this disclosure that various modifications, changes, improvements and variations may be made without departing from the scope of the invention.

1. A web service interrogation method comprising the steps of:
i) receiving natural language request data at a processor;
ii) parsing said request data at the processor;
iii) interrogating a data structure comprising a directory of web service resources based upon the parsed input data;
iv) matching fields within a web service identified from said data structure to the parsed input data; characterised by
v) aggregating service data records corresponding to at least some of said webs service resources that fulfill a matching criteria to said request data; and
vi) outputting said service data to a user.

2. The method of claim 1 comprising identifying a domain within the data structure to interrogate from the parsed input data.

3. The method of claim 2 comprising interrogating the data structure using UDDI.

4. The method of claim 1 comprising matching said fields with the parsed data within said data structure by the use of a descriptor schema.

5. The method of claim 4 comprising matching said fields using WSDL.

6. The method of claim 1 comprising outputting query data to the user should the number of service data records aggregated lie below a pre-determined threshold.

7. The method of claim 1 comprising outputting query data to the user should the parsed data be insufficient to match to all fields within the data structure required in order to aggregate service data records.

8. The method of claim 7 comprising parsing further natural language input data, input in response to said query data.

9. The method of claim 8 comprising repeating stages (iv) to (vi) in response to the further parsed input data.

10. The method of claim 1 comprising completing at least some fields within a web-form associated with one of said web-services using said parsed input data.

11. A web service interrogation apparatus comprising:
a processor;
a natural language data input device;
a display device;
the data input device being arranged to receive a natural language request data and to pass said request data to the processor;
the processor being arranged to parse said request data;
the processor being arranged to interrogate a data structure comprising a directory of web service resources based upon the parsed input data and being further arranged to match fields within an entry within a web service identified from the data structure to the parsed input data; characterised by
the processor being arranged to aggregate service data records corresponding to at least some of said webs service resources that fulfill a matching criteria to said request data; and
the processor being arranged to output said service data for display at the display device.

12. The apparatus of claim 11 wherein the data structure is hosted upon a data storage device remote from the processor.

13. The apparatus of claim 12 wherein the processor is arranged to access the data structure via a network.

14. The apparatus of claim 11 wherein the processor is arranged to interrogate the data structure using UDDI.

15. The apparatus of claim 11 wherein the processor is arranged to match said field with the parsed input data within said data structure by the use WSDL.

16. The apparatus of claim 11 wherein the natural language input device comprises any of the following: a keyboard, a voice recognition device, a mouse-display combination.

17. A processor arranged to operate as the processor of claims 11.

18. Software which when executed upon a processor causes the processor to:
receive natural language request data at a processor;
parse said request data at the processor;
interrogate a data structure comprising a directory of web service resources based upon the parsed input data;
match fields within an entry within said data structure to the parsed input data;
aggregate service data records corresponding to at least some of said webs service resources that fulfill a matching criteria to said request data; and
output said service data to a display device.

19. Software according to claim 18 which when executed upon a processor causes the processor to access the data structure via a network.

20. Software according to claim 18 which when executed upon a processor causes the processor to interrogate the data structure using UDDI protocols.

21. Software according to claim 18 which when executed upon a processor causes the processor to identify a domain to interrogate from the parsed input data.

22. Software according to claim 18 which when executed upon a processor causes the processor to match said field with the parsed input data within said data structure by the use of a descriptor schema

23. Software according to claim 18 which when executed upon a processor causes the processor to output query data to via the display device should the number of service data records aggregated exceed a pre-determined threshold.

24. Software according to claim 18 which when executed upon a processor causes the processor to output query data via the display device should the number of service data records aggregated lie below a pre-determined threshold.

25. Software according to claim 18 which when executed upon a processor causes the processor to output query data to the user should the parsed data be insufficient to match to all fields within the data structure required in order to aggregate service data records.

26. Software according to claim 25 which when executed upon a processor causes the processor to parse a further natural language input data, input in response to said query data.

27. Software according to claim 26 which when executed upon a processor causes the processor to interrogate a data structure comprising a directory of web service resources based upon the further parsed input data and further causing the processor to match fields within said data structure to the further parsed input data, and to cause the processor to aggregate service data records corresponding to at least some of said webs service resources that fulfill a matching criteria to said request data, and to cause the processor to output said service data for display at the display device.
